(19) United States
(12) Patent Application Publication
(10) Pub. No.: US 2013/0022725 A1
(43) Pub. Date: Jan. 24, 2013

(54) DETACHABLE FROZEN POP MOLDS

(71) Applicant: David Chan, Scarborough (CA)

(72) Inventor: David Chan, Scarborough (CA)

(21) Appl. No.: 13/558,701

(22) Filed: Jul. 26, 2012

Related U.S. Application Data
(63) Continuation of application No. PCT/CA2011/000148, filed on Feb. 10, 2011.
(60) Provisional application No. 61/303,141, filed on Feb. 10, 2010.

(51) Int. Cl. B41B 11/60; A23G 9/26; A23G 9/08

(52) U.S. Cl. 426/515; 249/163

(57) ABSTRACT

Provided is a detachable frozen pop mold for freezing edible fluids. The molds have vessels with cavities for holding the fluid. The mold vessels have connectors on their exterior sides for connecting a number of molds together. Molds can be detached and removed from the freezer either individually or in bunches as desired so that there are never empty frozen pop molds taking up space in the freezer.

### CROSS REFERENCE

This application is a continuation of PCT/CA2011/000148 filed Feb. 10, 2011, which PCT International Application claims priority to and/or the benefit of U.S. Provisional Application 61/303,141, filed Feb. 10, 2010.

### FIELD

The present disclosure relates to frozen treats and in particular to detachable frozen pop molds.

### BACKGROUND

Edible liquids, fluids and/or fluids with solids are often frozen in molds to form edible solid foods of a certain shape. Pop molds are commonly found together in single, integral sets of more than one pop mold so that multiple pops can be frozen simultaneously.

To make a frozen pop, edible liquid is first poured into the molds and a handle (e.g. a pop stick) is then immersed into the liquid. The molds containing the liquid and handle are then frozen. Solids, such as fruit pieces or pulp, candy or other particles including inedible particles (e.g. small toys or trinkets) may be mixed in with the liquids.

When a person wants to consume a single pop, that person removes a pop from a mold by grasping the pop stick and pulling the frozen pop from the mold. The now empty pop mold remains integrated with the full pop molds, thus taking up space in the freezer.

In other embodiments, a tray holds a plurality of molds in an array. individual molds may be removable from the tray and the tray and remaining molds placed back in the freezer.

The present invention addresses at least one of the above problems.

### SUMMARY

Provided is a detachable frozen pop mold for freezing edible fluids. The molds have vessels with cavities for holding the fluid. The mold vessels have connectors on their exterior sides for connecting a number of molds together. Molds can be detached and removed from the freezer either individually or in bunches as desired so that there are never empty frozen pop molds taking up space in the freezer.

Also provided is a detachable frozen pop mold, comprising a vessel defining a cavity with an opening at one end for receiving pop fluid for freezing, an external surface of the vessel having a first connector for removably attaching to a second connector of a second mold.

Also provided is a kit comprising a plurality of pop molds, each mold comprising a vessel defining a cavity with an opening at one end for receiving fluid for freezing, the vessel having a first connector attached to its outer surface and a second connector attached to its outer surface, the first connector for removably attaching to the second connector of another mold of the plurality of pops molds. The kit may comprise instructions for assembling two detachable pop molds.

Also provided is a method of preparing frozen pops, comprising the steps of: providing a plurality of detachable frozen pop molds, each mold comprising: a vessel defining a cavity with an opening at one end for receiving pop fluid for freezing, an external surface of the vessel having a first connector for removably attaching to a second connector of a second mold; attaching the first connector of one detachable pop mold to the second connector of another detachable pop mold to form a set of detachable pop molds; filling the cavities of the detachable pop molds in the set of detachable pop molds with pop fluid; and placing the set of detachable pop molds in a freezer.

In accordance with any of these aspects, a shape of the first connector and second connector may be selected to prevent the axial rotation of the connectors when attached.

### BRIEF DESCRIPTION OF THE DRAWINGS

In order that the subject matter may be readily understood, embodiments are illustrated by way of examples in the accompanying drawings, in which:

FIG. 1 is a side view of a detachable frozen pop mold in accordance with one embodiment

FIG. 2 is a side view of a vessel of a detachable pop mold;

FIG. 3 is a front view of a vessel of a detachable pop mold;

FIG. 4 is a top view of a vessel of a detachable pop mold;

FIG. 5 is a side view of a handle of a detachable pop mold;

FIG. 6A-6F are cross-sectional views of different embodiments of connectors;

FIG. 7 is a front view of a plurality of detachable pop molds attached together; and

FIG. 8 is a flowchart of a method of making frozen pops using the detachable pop molds.

### DETAILED DESCRIPTION

A detachable pop mold 100 is illustrated in the accompanying Figures.

Detachable pop molds 100 can be used to freeze a desired number of pops. Pop molds 100 are attached together and may be filled with edible pop fluid for freezing. Pop fluid may comprise a liquid, a gelatin product (e.g. Jello® brand), a pudding, a yogurt, etc. or combinations of liquids, solids and semi-solids. The molds 100 may then be frozen (e.g. by placing the molds 100 in a freezer) in order to make pops in the shape of the molds. After the pops are frozen in the pop molds 100, the pop molds 100 can then be detached one-by-one, leaving only the pop molds 100 that contain frozen pops in the freezer. Pops can then be removed from the pop molds 100 and consumed.

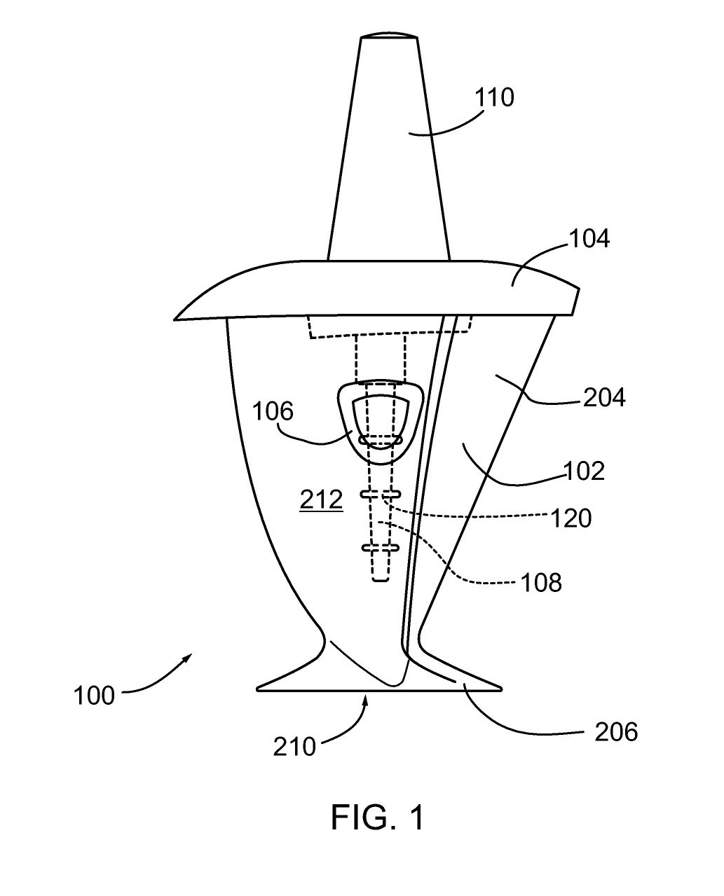

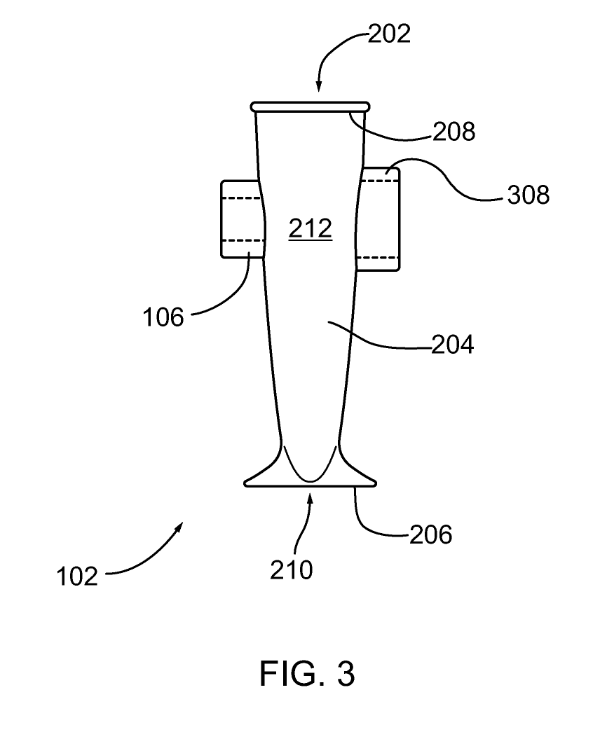

Referring to FIG. 1, each detachable pop mold 100 may comprise a vessel 102. Each mold 100 may also comprise a first connector 106 and second connector 308 (see FIG. 3, e.g.) on opposing sides of the exterior of the vessel 102. The first connector 106 is sized to removably attach to a cooperating second connector 308 of a second mold 100 (see Figures) so that two or more pop molds 100 can be attached or secured together until they are pulled apart (or otherwise detached). The mold 100 may also comprise a handle 110, a lid 104 attached to the handle 110, an arm 108 extending from the handle 110 and a stand 206 attached to the vessel 102. The first connector 106 and the second connector 308 are not necessarily on opposing sides of the vessel 102.

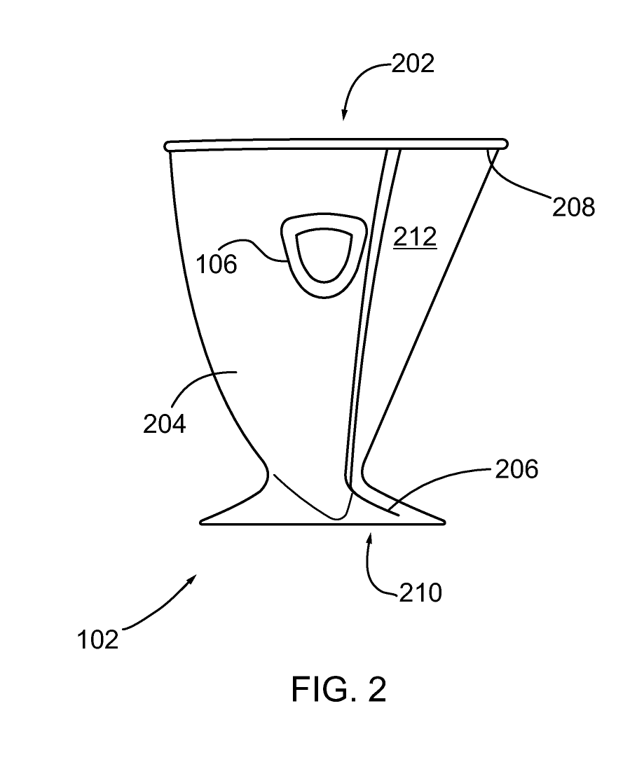

Referring to FIGS. 2 to 4, the vessel 102 has a wall 204 with a bottom surface 402 and an open end 220 defining an interior cavity 202. The stand 206 may be attached to the vessel 102 opposite the open end 220 of the cavity 202. The stand may, alternatively, be integral with the vessel 102. The stand 206 has a planar bottom surface 210 for resting on another surface (such as a countertop or freezer floor or shelf, for example) to support the remainder of the pop mold 100 in an upright position so that the vessel 102 may hold pop fluid without the fluid spilling out of the open end 220. The stand 206 may, alternatively, be a separate component that the remainder of the vessel 102 rests upon.

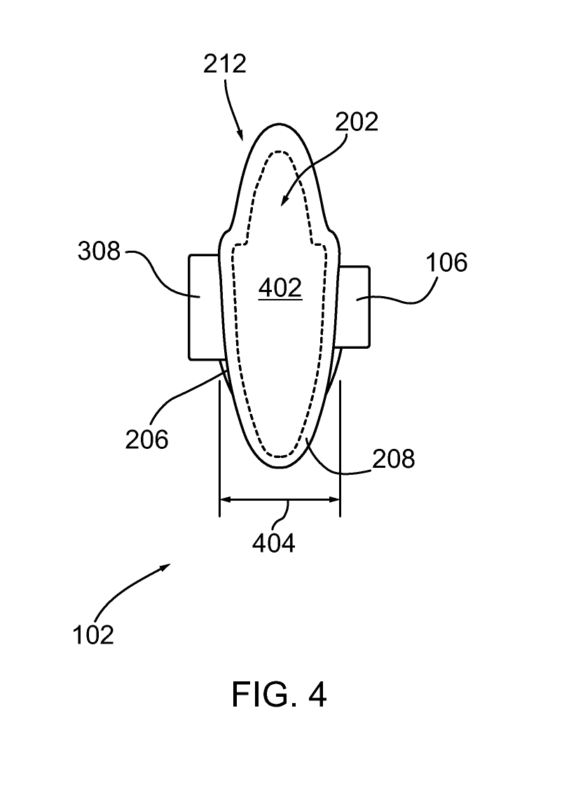

The interior cavity 202 forms the shape of the mold used for freezing the pop fluid into a particular shape. This mold may be in the shape of a sail, as shown in the Figures. Alternatively, the mold may be in any one of numerous shapes, typically tapering to the from the top to the bottom to assist with removal of the frozen pop. such as a tube or a square. It is recognized that in order to remove a frozen pop from a detachable pop mold 100, after a fluid is frozen into the shape of the mold, the open end 220 must be sized to allow the frozen pop to pass therethrough. For example, the open end 220 may have a width 404 (see FIG. 4) greater than the greatest width of the mold defined by the interior cavity 202.

The exterior surface 212 of the wall 204 of the vessel 102 supports the first connector 106 as well as the second connector 308. The first connector 106 and the second connector 308 may be on opposite sides of the exterior surface 212 of the wall 204 of the vessel 102, for example. However, it is not necessary that the first connector 106 and the second connector 308 are on opposite sides of the exterior surface 212 of the wall 204 of the vessel 102.

The first connector 106 of one pop mold 100 is removably attachable to the second connector 308 of another pop mold 100. At least in some embodiments, the first and second connectors comprise cooperating male and female connectors, whereby the first connector is received within the second connector or vice versa or combinations thereof (e.g. whereby a portion of the first connector is received within the second connector and a portion of the second connector is received within the first connector. For example, when attached, the first connector 106 and second connector 308 may be in a telescoping engagement, with one of the connectors 106, 308 fitting over the other connector 106, 308. The shape of the cooperating first and second connectors may be chosen such that when attached, the connectors are prevented from axial rotation (e.g. about a central axis of the first connector 106). For example, the shape in cross-section of each connector 106, 308 is preferably non-circular. Circular shapes may rotate axially (about the centre of the circle) while cooperating non-circular shapes tend not to rotate. In one embodiment, the first connector 106 may comprise an extension defining an exterior surface having a non-circular cross-section for inserting into the second connector 308 having a complimentary shape in a friction fit.

As shown in the exemplary embodiment illustrated in the Figures, the second connector 308 may have an irregular (i.e. non-circular) ring-like shape extending outwardly from the external surface 212 of the wall 204. The irregular ring-like shape may be a rounded triangle surrounding an interior and this interior may be sized to fit a first connector 106. The fit may, for example, be a friction fit wherein the shape of the first connector 106 is complimentary to the interior of the irregular ring-like shape of the second connector 308 so that the first connector 106 fits snugly inside of the second connector 308. When the first connector 106 of one detachable pop mold 100 is attached to a second connector 308 of another detachable pop mold 100, the two detachable pop molds may be easily separated by pulling them apart.

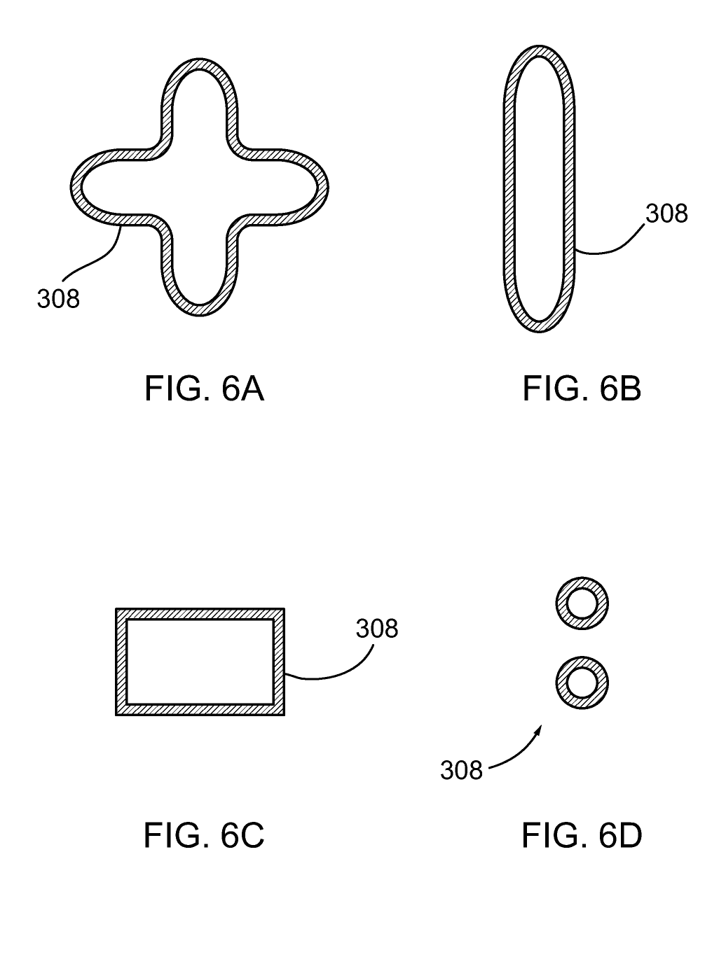

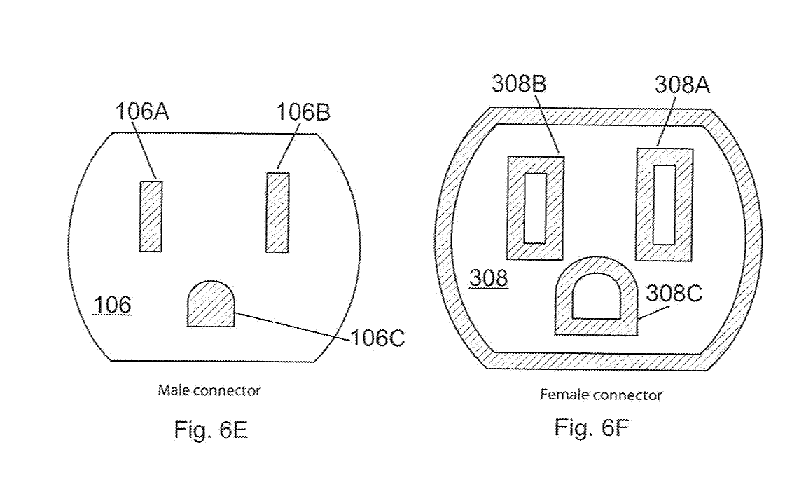

The second connector 308 may define an interior having a shape other than a rounded triangle. For example, the second connector 308 may define a rounded cross (FIG. 6A), a rounded elongated egg (FIG. 6B) or a rectangle (FIG. 6C). The first connecter 106 may have a shape that is complimentary to the second connector 308 in order to secure the respective pop molds 100 together. Using single non-circular shapes defined by the interior of the second connector 308 ensures that two detachable pop molds will not rotate relative to one another. It is recognized that FIGS. 6A to 6C are example shapes only and that the interior of the second connector 308 can define other non-circular shapes.

Alternatively, two (or more) extensions of the second connector 308 may each define interiors and the first connector 106 may have two (or more) extensions which are complimentary to and fit into the two (or more) interiors of the second connector 308. For such a second connector 308 to attach to the first connector 106 the number of extensions of the first connector 106 is preferably equal to the number of interiors defined by the extension of the second connector 308. The two (or more) interiors of the second connector 308 may each define a circular or differently shaped interior. FIG. 6D, for example, shows a cross-section of a second connector 308 defining two circular interior shapes. For example, the first connector 106 may comprise a plurality of extensions defining exterior surfaces for inserting into a plurality of second connectors 308 having complimentary shapes in a friction fit. In such a case the number of extensions of the first connector 106 may be no more than the number of second connectors 308. FIGS. 6E and 6F illustrate a further first connector 106 and a second connector 308 comprising cooperating portions 106A, 106B, 106C and 308A, 308B and 308C in a male and female combination that does not rotate axially when engaged.

In further alternatives, the first connector 106 and second connector 308 may be removably attachable using a snap fit or using other similar removable connections or means of attachment that are known to a skilled person.

It is recognized that a detachable pop mold 100 may only have one connector for connecting to a single other detachable pop mold 100. Alternatively, the detachable pop mold 100 may have three or more connectors (e.g. two first connectors and two second connectors on a four sided mold) for connecting to a plurality of other pop molds 100.

The wall 204 of the vessel 102 may be transparent, translucent or opaque. The vessel 102 may be made from non-toxic food-friendly materials, such as metals, plastic or other types of polymers capable of being frozen and handled without breaking Further, the vessel may be made from a single piece of molded plastic. For example, the vessel may be made using a plastic extruder or using an injector for injecting molten plastic into a mold in the form of the vessel. Other alternatives to making the vessel using a single piece of plastic or so that the vessel itself is a single piece of plastic that are familiar to a person of ordinary skill in the art may be implemented.

Referring to FIG. 6, the handle 110 is shown with an arm 108 extending therefrom. The handle 110 and the arm 108 together may form a linear member. A lid 104 circumnavigates the linear member delineating the handle 110 from the arm 108. It is recognized that a lid 104 is not necessary for the operation of the pop molds 100. The lid 104 may be sized to fit over the open end 220 of the vessel 102. Further, the lid 104 may provide a barrier between a person's hand and the frozen pop so that if the pop is held upright and the frozen pop melts, the resulting liquid will drip into the underside 502 of the lid 104 thereby at least partially preventing the liquid from dripping onto a person's hand.

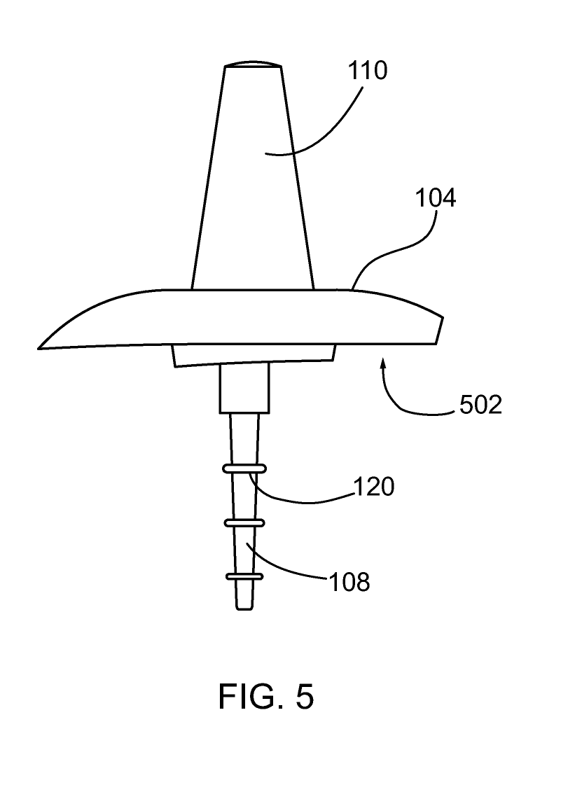

The arm 108 may have at least one gripper 120 attached to its outer surface for frictionally gripping frozen pop fluid contained in the cavity 202 of the vessel 102. The at least one gripper 120 may be a rib circumnavigating a portion of the arm 108. FIG. 5, for example, shows three annular ribs 120 circumnavigating the arm 108. The ribs 120 may provide a frictional attachment to the frozen pop fluid in the cavity 202 when the fluid is frozen around the arm 108 so that when the frozen pop is removed from the vessel 102 by pulling the handle 110 away from the vessel 102, the frozen pop is removed from the vessel 102 along with the arm 108 rather than remaining in the cavity 202 of the vessel 102.

The handle 110, which extends in the opposite direction as the arm 108, may be removably engageable with the vessel 102 by placing the arm 108 into the cavity 202 of the vessel 102. The handle 110 is sized so that the handle 110 extends exterior to the cavity 202 of the vessel 102 when the arm 108 is at least partially inside of the cavity 202 of the vessel 102. The handle 110 is engaged with the vessel 102 when the arm 108 is extending into the pop fluid in the vessel and the handle 110 is extending exterior to vessel 102 so that the handle 110 can be grasped while the arm 108 remains in the pop fluid in the vessel 102.

The edge of the lid 104 may be sized to fit outside of the edge 208 of the vessel 102. Thus the lid 104 can sit on top of the open end 220 of the vessel 102. In such a position, the arm 108 extends into the interior cavity 202 of the vessel 102 through the open end 220 of the vessel. It is recognized that for the lid 104 to sit on the edge 208 of the open end 220 of the vessel 102, the arm 108 must have a length shorter than the depth of the interior cavity 202 of the vessel 102.

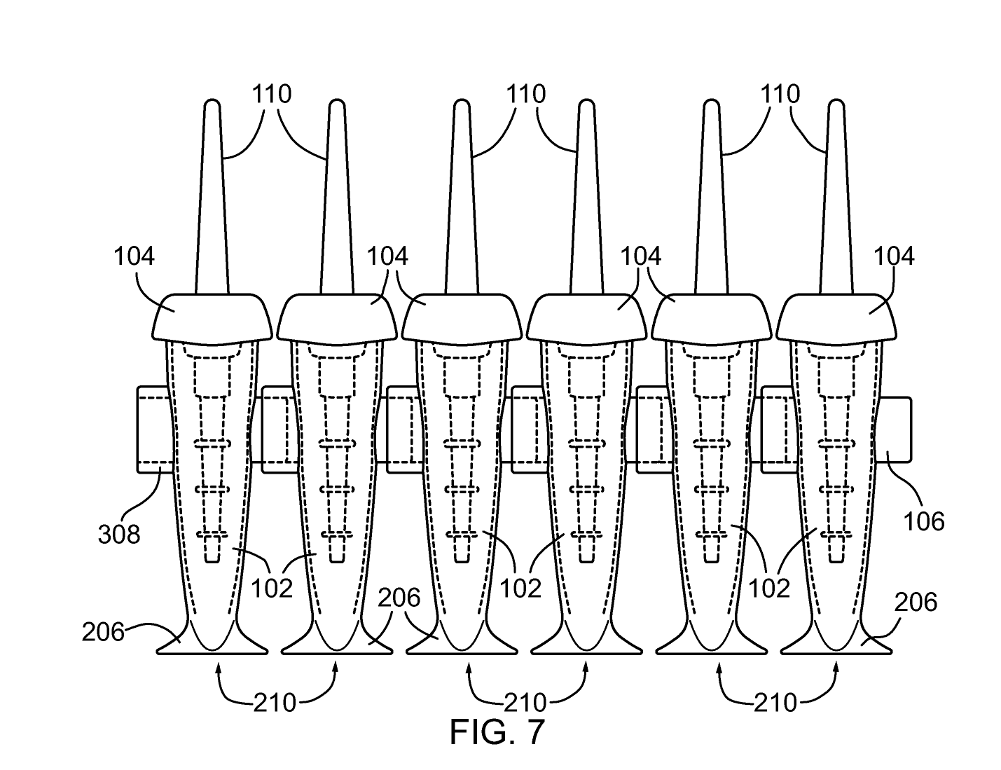

Referring to FIG. 7, detachable pop molds 100 may be attached to one another. For example, the second connecter 308 of a first pop mold 100A may be removably attached to the first connector 106 of a second mold 100B. Similarly, a second connecter 308 of the second pop mold 100B may be removably attached to the first connector 106 of a third pop mold 100C. The remaining pop molds 100D, 100E, 100F may be similarly attached.

The first connector 106 and the second connector 308 may be any suitable attachment means familiar to a skilled person.

As the vessel 102 may be transparent, the arm 108 may be seen through the wall 204 of the vessel 102 when the handle 110 is engaged with the vessel 102.

A plurality of detachable pop molds 100 may be sold in a kit. The kit may also include instructions for assembling two detachable pop molds 100. By following the instructions a person could first attach two detachable pop molds 100 together, followed by attaching a third detachable pop mold 100 to one of the two original pop molds 100, thus forming a set of three detachable pop molds 100. A person could iteratively follow these instructions in order to assemble the entire plurality of detachable pop molds 100 in the kit, for example.

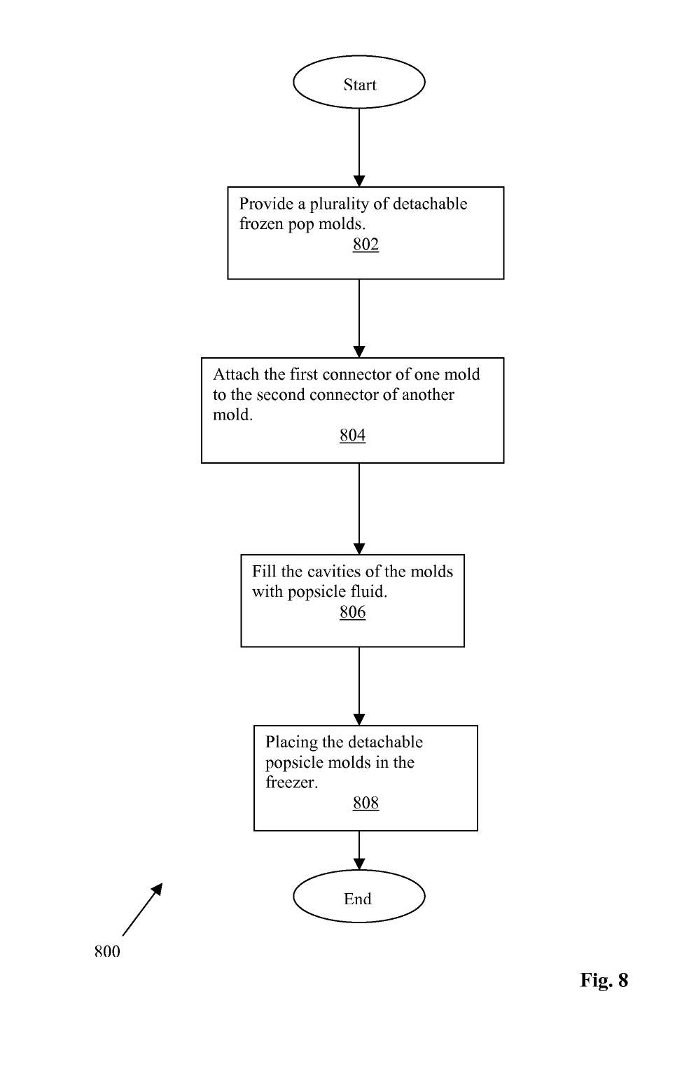

A flowchart 800 showing the method of preparing frozen pops using the pop molds 100 is shown in FIG. 8.

At step 802, a plurality of detachable frozen pop molds 100 is provided. As described above, each mold 100 comprises a vessel 102 defining a cavity with an opening 220 at one end for receiving pop fluid for freezing, an external surface of the vessel 102 having a first connector 106 for removably attaching to a second connector 308 of a second mold 100.

At step 804, the first connector 106 of one of the provided detachable pop molds 100 is removably attached to the second connector 308 of another of the provided detachable pop molds 100. This forms a set of detachable pop molds 100.

It is recognized that the first connector 106 may be universal connector meaning that the first connector 106 can attach to either a second connector 308 or another first connector 106. It is similarly recognized that the second connector 308 may be a universal connector.

At step 806, the cavities of the detachable pop molds 100 in the set of detachable pop molds 100 are filled with pop fluid. The pop fluid may be any edible fluid. For example, the pop fluid may be a fruit juice, water mixed with sugar, or other flavoured liquids.

It is recognized that the step of attaching the first connector 106 of one detachable pop mold 100 to the second connector 308 of another detachable pop mold 100 could happen after the steps of filling the cavities 202 of the detachable pop molds 100 with pop fluid.

At step 808, the set of detachable pop molds 100 is placed in a freezer. The detachable pop molds 100 may be left in the freezer until the pop fluid in the pop molds 100 is frozen, forming frozen pops.

Additional pop molds 100 may be similarly attached together and filled with pop fluid for freezing.

Optionally, handles 110 may be used with any number of the detachable pop molds 100 in the set of detachable pop molds 100. For example, the handle 110 of a first detachable pop mold 100 may be engaged with the vessel of the first detachable pop mold 100. Specifically, the extending arm 108 of the handle 110 may be inserted into the cavity 202 of the vessel 102 so as to be at least partially immersed in the pop fluid in the vessel 102. The lid 104 of the handle 110 may then abut the edge 208 of the vessel 102 thereby supporting the handle 110 in an upright position extending away from the cavity, as shown in FIG. 1.

The pop molds 100 in the freezer can be selectively detached from each other so that a person can selectively remove a desired number of pops molds 100 containing frozen pops from the freezer. For example, a person can detach the first connector 106 of one detachable pop mold 100 from the second connector 308 of another detachable pop mold 100 and then remove only the first detachable pop mold 100 from the freezer. It is recognized that a single detachable pop mold 100 may be removably attached to more than one other detachable pop mold 100.

The frozen pop itself can be removed from a detachable pop mold 100 by simply separating or remove the handle 110 from the vessel 102 of the pop mold 100. The ribs 120 on the arm 108 provide a further frictional attachment between the arm 108 and the frozen pop.

One or more currently preferred embodiments have been described by way of example. It will be apparent to persons skilled in the art that a number of variations and modifications can be made without departing from the scope of the invention as defined in the claims.

What is claimed is:

1. A detachable frozen pop mold, comprising:
a vessel defining a cavity with an opening at one end for receiving pop fluid for freezing, an external surface of the vessel having a first connector for removably attaching to a second connector of a second mold.

2. The detachable frozen pop mold of claim 1, wherein a shape of the first connector and second connector are selected to prevent the axial rotation of the connectors when attached.

3. The detachable frozen pop mold of claim 1, wherein the first connector comprises an extension defining an exterior surface having a non-circular cross-section for inserting into the second connector having a complimentary shape in a friction fit.

4. The detachable frozen pop mold of claim 1, wherein the first connector comprises a plurality of extensions defining exterior surfaces for inserting into a second connector of another mold in a friction fit.

5. The detachable frozen pop mold of claim 1, wherein the external surface of the vessel further comprises a second connector for removably attaching to a third mold.

6. The detachable frozen pop mold of claim 5, wherein the first connector and the second connector on the same vessel are on opposite sides of the vessel.

7. The detachable frozen pop mold of claim 1, further comprising a lid attached to the handle, the lid shaped to cover the opening of the cavity when the handle is removably engaged with the vessel.

8. The detachable frozen pop mold of claim 1, further comprising:
a handle having an arm extending therefrom, the handle removably engageable with the vessel, in the engaged position the arm extends into the cavity and the handle extends away from and exterior to the cavity.

9. The detachable frozen pop mold of claim 8, wherein the arm comprises at least one gripper for frictionally attaching the arm to the frozen pop fluid contained in the vessel.

10. The detachable frozen pop mold of claim 1, further comprising a stand attached to the exterior of the vessel opposite the opening of the cavity, the stand for supporting the detachable frozen pop mold on a surface.

11. The detachable frozen pop mold of claim 1, wherein the vessel is a single piece of molded plastic.

12. A kit comprising:
a plurality of pop molds, each mold comprising a vessel defining a cavity with an opening at one end for receiving fluid for freezing, the vessel having a first connector attached to its outer surface and a second connector attached to its outer surface, the first connector for removably attaching to the second connector of another mold of the plurality of pops molds.

13. The kit of claim 12, wherein a shape of the first connector and second connector are selected to prevent the axial rotation of the connectors when attached.

14. The kit of claim 12, wherein the first connector comprises an extension defining an exterior surface having a non-circular cross-section for inserting into the second connector having a complimentary shape in a friction fit

15. The kit of claim 12, wherein the first connector comprises a plurality of extensions defining exterior surfaces for inserting into the second connector of another mold in a friction fit.

16. The kit of claim 15, wherein the first connector and the second connector on the same vessel are on opposite sides of the vessel.

17. The kit of claim 12, further comprising instructions for assembling the pop molds.

18. A method of preparing frozen pops comprising the steps of:
providing a plurality of detachable frozen pop molds, each mold comprising:
a vessel defining a cavity with an opening at one end for receiving pop fluid for freezing, an external surface of the vessel having a first connector for removably attaching to a second connector of a second mold, a shape of the first connector and second connector being selected to prevent the axial rotation of the connectors when attached;
attaching the first connector of one detachable pop mold to the second connector of another detachable pop mold to form a set of detachable pop molds;
filling the cavities of the detachable pop molds in the set of detachable pop molds with pop fluid; and
placing the set of detachable pop molds in a freezer.

19. The method of claim 18, wherein the step of attaching the first connector of one detachable pop mold to the second connector of another detachable pop mold is performed before the step of filling the cavities of the detachable pop molds in the set of detachable pop molds with pop fluid.

20. The method of claim 18, further comprising selectively detaching one of the detachable pop molds from the set of detachable pop molds.
